(19) United States
(12) Patent Application Publication
(10) Pub. No.: US 2008/0284125 A1
(43) Pub. Date: Nov. 20, 2008

(54) Steerable Kneeling Walker

(76) Inventors: Sharalyn S. Ramm, Edmonds, WA (US); Anton Donald Ptacek, Edmonds, WA (US)

Correspondence Address: AXIOS LAW GROUP. PLLC, 1525 FOURTH AVENUE, SUITE 800, SEATTLE, WA, 98101, US

(21) Appl. No.: 12/095,915

(22) PCT Filed: Dec. 4, 2006
(86) PCT No.: PCT/US06/61580

§ 371 Date: Jun. 2, 2008

Related U.S. Application Data
(60) Provisional application No. 60/741,954, filed on Dec. 2, 2005.

(51) Int. Cl. B62K 21/00

(52) U.S. Cl. 280/263

(57) ABSTRACT

This invention relates to a kneeling walker comprising a frame; a steering assembly coupled to a frame of the kneeling walker and having a steering stem and a control assembly; and a handle assembly coupled to the steering stem.

### RELATED INVENTIONS

This application claims the benefit of U.S. Provisional Application No. 60/741,954, entitled IMPROVED STEERABLE KNEELING WALKER, filed on Dec. 2, 2005, hereby incorporated by reference.

### FIELD

The present invention relates to walking aids, in particular, to a steerable kneeling walker that supports one leg and can be propelled using the other leg

### BACKGROUND

Various devices have been created to aid in the mobility of individuals with disabled lower legs. The most common examples of such devices are wheel chairs, walkers and crutches.

Wheel chairs are commonly used by the disabled as a means of transportation. The seated occupants generally propel themselves by turning the rear wheels of the wheel chair with their arms and hand. Wheel chairs are generally large, heavy structures that can be difficult to propel and maneuver. This is especially true for the young and elderly or someone that lacks upper body strength. While wheel chairs can also be propelled by a motor or by a third party, they take up considerable space and are difficult to use in confined or crowded spaces. Access is also limited to buildings that have ramps specifically designed for wheel chairs. Wheel chairs also take up considerable space when not in use and while they are often collapsible, given their size and weight, transportation and storage is often difficult. Although wheel chairs offer the most viable means of transportation to individuals that have limited or no use of both legs, they are overly burdensome for use by individuals with only one disabled leg.

Walkers offer an alternative to wheel chairs in that they are smaller, lighter and easier to transport. But, unlike wheel chairs, the user must stand in order to propel the walker. While a walker offers support and balance to the user, it must be lifted or pushed from location to location. Significant upper body strength on the part of the user is necessary particularly if they have a cast on their leg or have problems standing. Speed in mobility is also significantly reduced as the user must push or lift the walker from place to place.

Crutches offer another alternative. While light in weight and transportable, crutches require upper body strength, balance and agility to operate. Mobility is accomplished almost exclusively through the use of the operator's arms with most of the operator's weight being supported through their hands, forearms and armpits. The ability of the individual to carry anything during use is therefore extremely limited and impractical. At rest, the user will support their weight by locating the crutches beneath the user's armpits. Although this position will free up the hands of the user, the resulting posture often causes additional pain and discomfort to the user's arms and back. Crutches are also highly unstable and increase the risk of further injury due to a fall caused by the loss of balance or misplacement of one or both crutches.

The kneeling walker combines the ease of light weight, mobility and transportation of the walker and crutches with the wheeled stability and support of the wheelchair. While the basic concepts of the kneeling walker are known, such kneeling walkers are not easy to use, steerable or collapsible into a compact form. Stability is also limited as they are either unsteerable and must be lifted to turn, or they have uncontrollable multi-directional wheels.

While some current walkers are foldable, their overall size is not significantly reduced when folded. This is due to the fact that most foldable kneeling walkers only fold in a single direction and can therefore only reduce their length, width or height by folding. Such kneeling walkers are not capable of being collapsed into a compact size and are therefore difficult to store and transport from place to place.

Current kneeling walkers are also symmetrically designed and can not readily be modified to accommodate a person with either a left or right disabled leg. The symmetrical design also forces the user into an unnatural position while propelling the walker. Leg movement and weight distribution normally used while walking must be altered when using the current kneeling walkers. Similarly, current kneeling walkers cannot adequately adjust to accommodate users of different sizes.

### BRIEF DESCRIPTION OF THE DRAWINGS

FIG. 1 is a side view of the kneeling walker in use according to an embodiment of the invention.

FIG. 2 is a full side view of the kneeling walker according to an embodiment of the invention.

FIG. 3 is a full side view of the kneeling walker in its collapsed position according to an embodiment of the invention.

FIG. 4 is a close up view of the support platform assembly according to an embodiment of the invention.

FIG. 5 is a front view of the kneeling walker according to an embodiment of the invention.

FIG. 6A is a close up view of the foldable locking assembly in its unlocked and folded position according to an embodiment of the invention.

FIG. 6B is a close up view of the foldable locking assembly in its locked position according to an embodiment of the invention.

FIG. 7A is a side view of the kneeling walker frame according to an embodiment of the invention.

FIG. 7B is an underside view of the kneeling walker frame according to an embodiment of the invention.

FIG. 8 is a close up view of the control assembly according to an embodiment of the invention.

### DETAILED DESCRIPTION

The improved kneeling walker described herein allows the user to stand in an upright position while supporting most of the user's weight on an adjustable cushioned platform. A handle and steering stem are provided for balance and control and are both collapsible for ease of storage and transportation. The cushioned platform accommodates the user's disabled leg in a bent configuration thereby distributing the user's weight through their upper leg to the cushioned platform. The kneeling walker is both steerable and stable. In some embodiments, it includes two fixed wheels and two independent directional wheels. A hand brake may also be provided to aid the user in slowing or stopping the device. The height of both the handle and the cushioned platform can be adjustable to accommodate users of a variety of sizes. The handle and steering stem can collapse for storage and transportation, as does the cushioned platform which can also be removable.

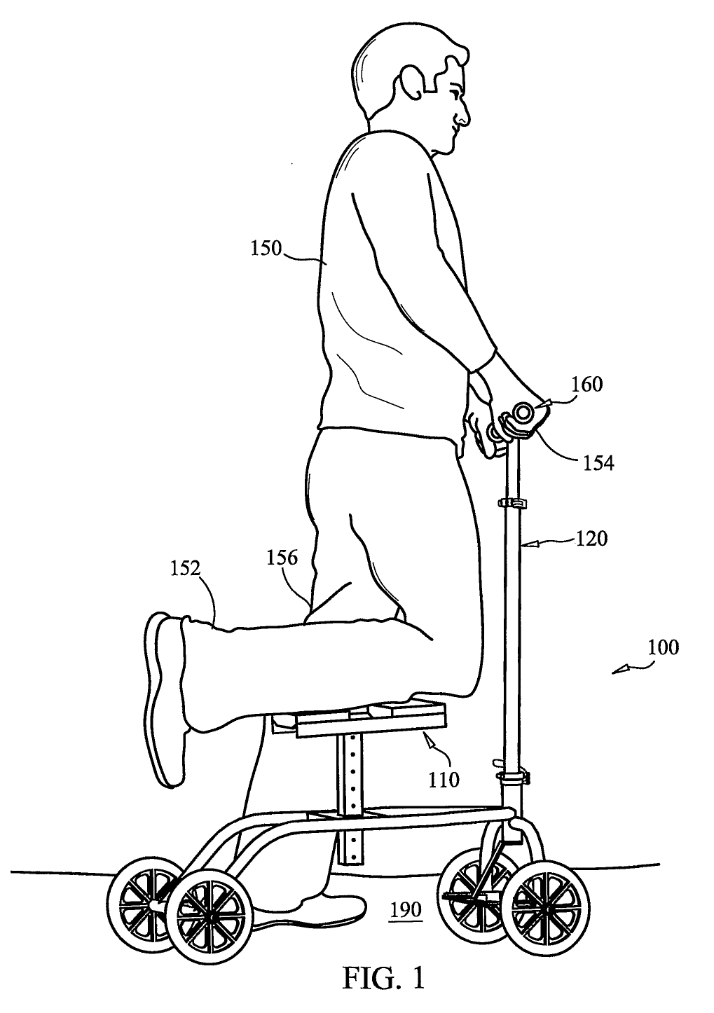

FIG. 1 shows an embodiment of the kneeling walker 100 in use by a person 150. The kneeling walker 100 is shown facilitating a movement of a person 150 along a surface 190. The person's disabled leg 152 is shown supported upon the adjustable support platform assembly 110, with the person's hands 154 shown engaging the handle assembly 160 which is attached to the adjustable steering stem 120. The person's capable leg 156 is used to propel the kneeling walker 100 across the surface 190.

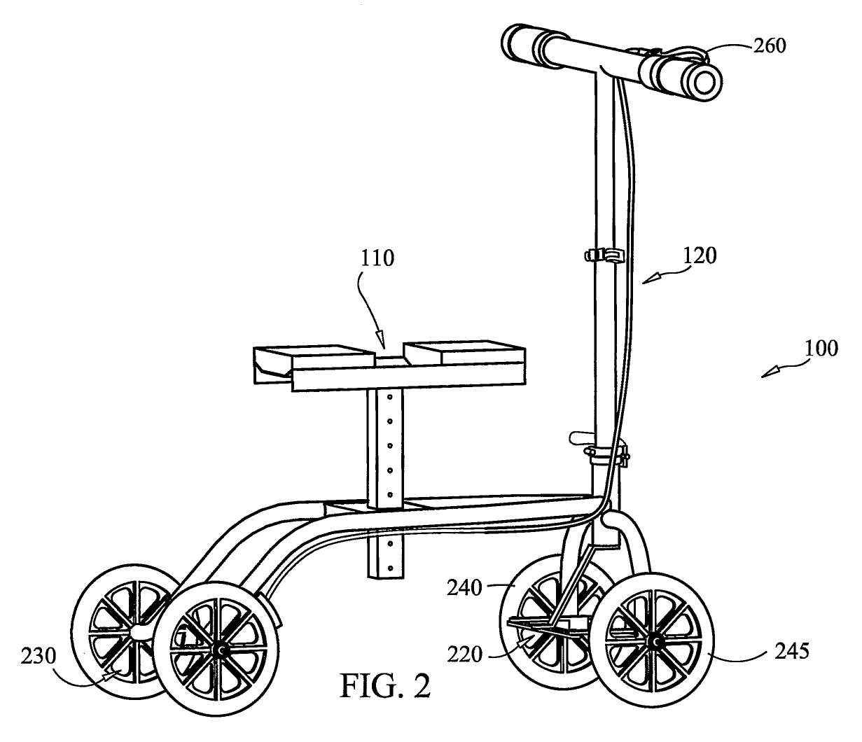

FIG. 2 shows an example of the kneeling walker 100. The kneeling walker 100 comprises a frame 210, an adjustable support platform assembly 110, an adjustable steering stem 120, a handle assembly 160, a control assembly 220, rear wheel assembly 230, left front wheel 240 and right front wheel 245. FIG. 2 also shows an embodiment of kneeling walker 100 that includes brake system 260.

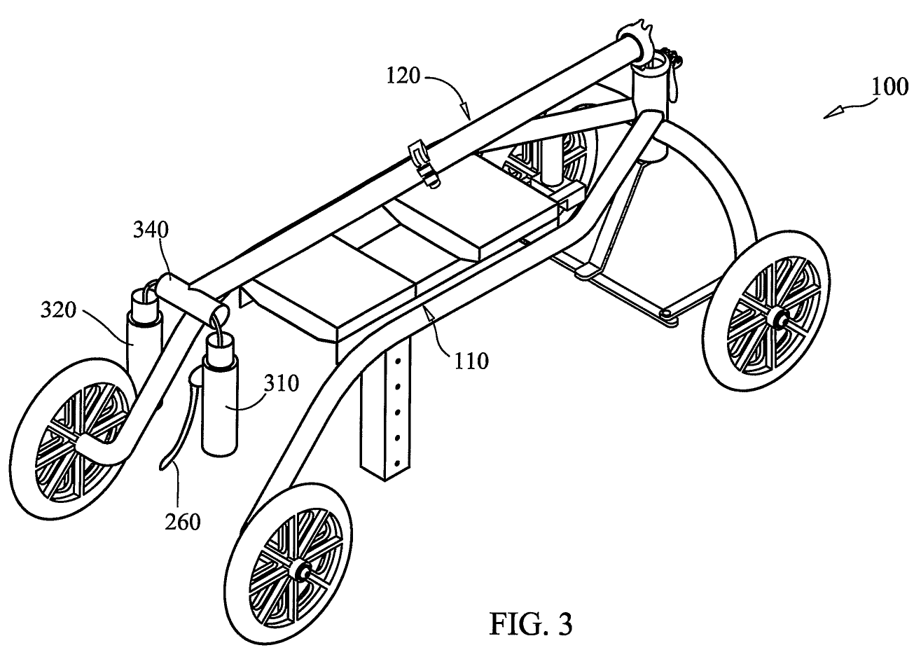

FIG. 3 shows another embodiment of the kneeling walker 100 in collapsed form with the adjustable support platform assembly 110 in its lowermost position and the adjustable steering stem 120 in its collapsed and folded position. Handle assembly 160 can further be comprised of left handle 310, right handle 320, handle mount 340 and a handle tether 330. The left handle 310 and the right handle 320 can be inserted and removed from the handle mount 340 for increased compactness, portability and storage. Handle tether 330 supports the left handle 310 and the right handle 320 while they are in the collapsed position. In another embodiment, left handle 310 and right handle 320 could telescope into handle mount 340 for compactness without the need for handle tether 330. In still another embodiment, left handle 310 and right handle 320 could be affixed to the handle mount 340 wherein handle mount 340 could then be removably attached to the adjustable steering stem 120. The entire handle assembly 160 could then be removed for compactness. Other handles, wheels or other steering structures may be used on alternate embodiments.

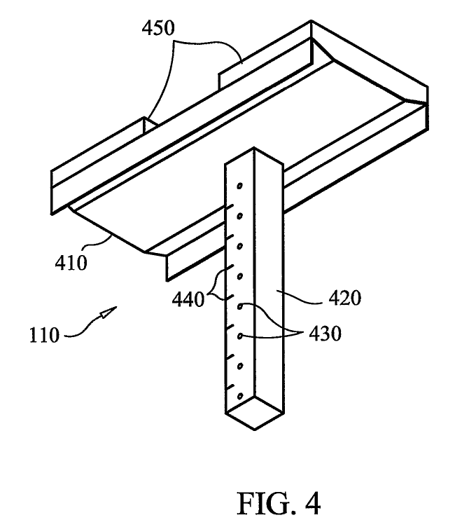

FIG. 4 shows a close up of one example of the adjustable support platform assembly 110. Plate 410 is attached to platform stem 420 in an asymmetric manner to the centerline of the frame 210 such that the adjustable support platform assembly 110 can be positioned to accommodate a person 150 with a left or right disabled leg 152. The asymmetrical position allows the kneeling walker 100 to be positioned underneath the disabled leg 152 but away from the capable leg 156 during movement. The capable leg 156 that propels the kneeling walker 100 will therefore not be hindered during use and can propel the kneeling walker 100 without having to make movements unnatural to the movements those necessary to walking. The asymmetrical design allows the kneeling walker 100 to be used when either the person's left or right leg is disabled by simply turning the adjustable support platform 110 180 degrees within the frame 210. The asymmetrical design allows the user to maintain an upright position similar to the user's natural walking position while propelling the kneeling walker 100. Normal leg movement and weight distribution is therefore maintained. The asymmetrical design also allows the user's weight to be distributed along the center line of the frame 210, thereby preventing tipping and maintaining stability during use. The platform stem 420 can be further comprised of a plurality of length stops 430 and a plurality of position indicators 440 to accommodate the different heights of persons 150 and to track the position of the adjustable support platform assembly 110. The platform stem 420 is shown in this embodiment as being rectangular for ease of manufacture, assembly and rigidity in construction. One or more pads 450 can be attached to the plate 410 to provide comfort and support for the disabled leg 152 of the person 150. The pads 450 can also be removable, replaceable and interchangeable. The pads 450 can also be integrated into the entire length of the horizontal platform 410 thereby removing the need to alter the position of the pads 450 when the adjustable support platform assembly 110 is relocated for use with an alternate disabled leg 152. The adjustable support platform assembly 110 can be made of metal, aluminum, composite material, graphite or like material. While an asymmetrical design is shown, various embodiments may include various levels of asymmetry and/or symmetry.

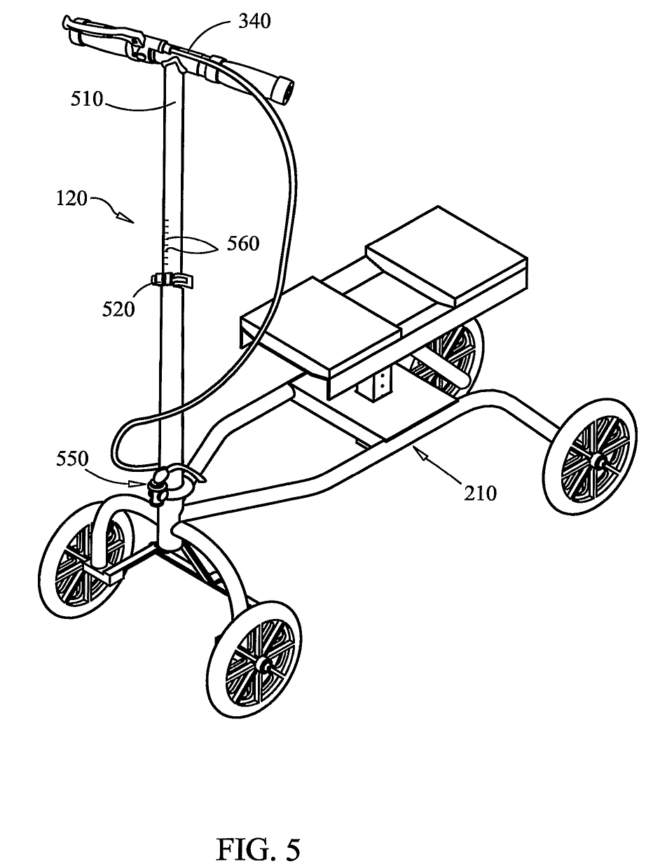

FIG. 5 shows a close up of another embodiment of the adjustable steering stem 120. The adjustable steering stem 120 is comprised of telescoping stem 510, locking collar 520, a plurality of height indicators 560, and foldable locking assembly 550. The telescoping stem 510 is telescoping in nature and can be elongated or compressed to accommodate various heights; it is locked in position by locking collar 520. The height and position of the telescoping stem 510 can be noted using the plurality of height indicators 560, for ease of reassembling the kneeling walker 100 from its collapsed position. The locking collar 520 can be a quick release type collar for ease and speed in height adjustment. Handle mount 340 can be attached to the top of the telescoping stem 510 and connects the left handle 310 and right handle 320 to the telescoping stem 510. The telescoping stem 510 can be attached to the frame by a foldable locking assembly 550 so the adjustable steering stem 120 can be collapsed to a horizontal position for ease of storage and transportation.

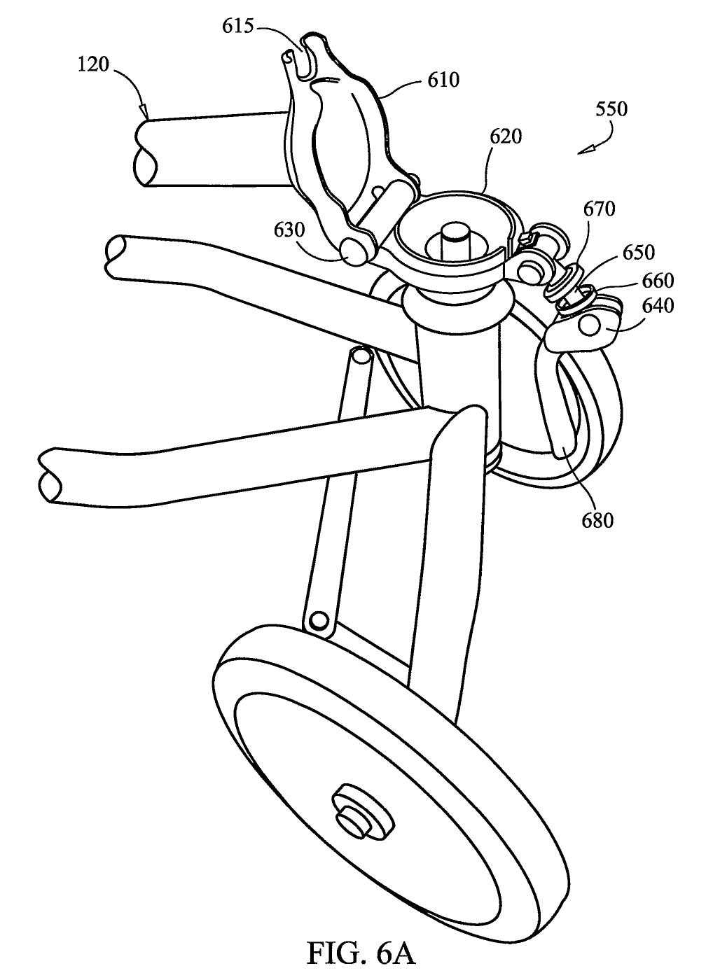

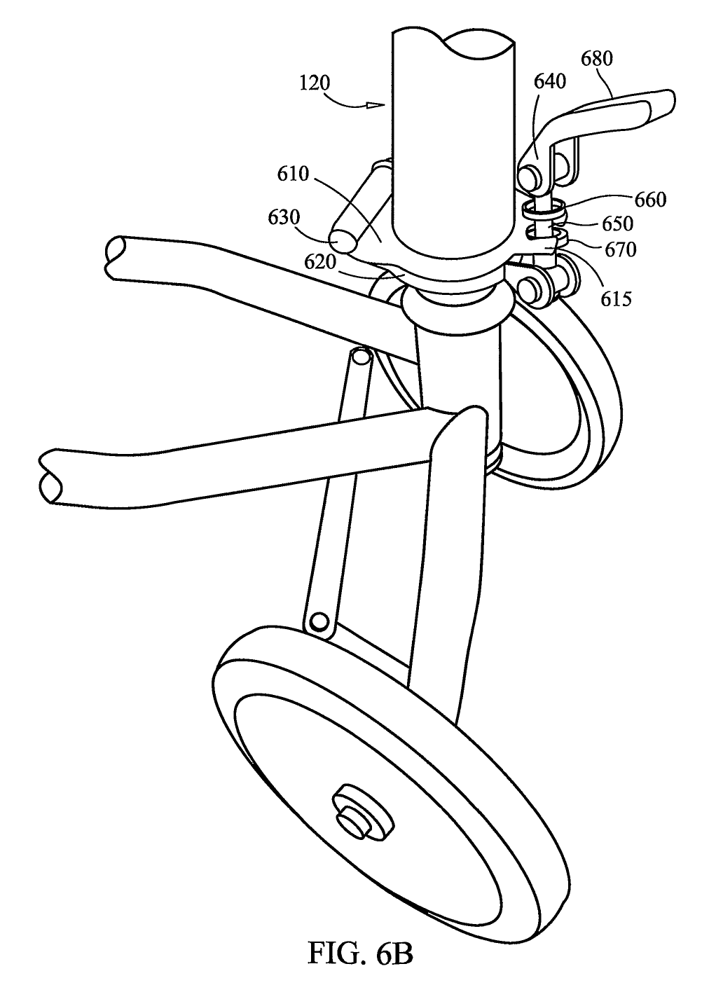

FIG. 6A shows an example embodiment of the foldable locking assembly 550 with the adjustable steering stem 120 in a folded, horizontal position. The foldable locking assembly 550 is comprised of top hinge plate 610, U-clasp 615, bottom hinge plate 620, plate pin 630, cam lever 640, lever pin 650, upper lever ring 660, lower lever ring 670, and lever handle 680. Top hinge plate 610 is hingeably connected to bottom hinge plate 620 by plate pin 630. Lever pin 650 is rotatably attached to cam lever 640 and pivotably attached to bottom hinge plate 620. Upper lever ring 660 and lower lever ring 670 are movably attached about lever pin 650 between cam lever 640 and bottom hinge plate 620.

FIG. 6B shows an embodiment of the foldable locking assembly 550 when the adjustable steering stem 120 is positioned for use. Foldable locking assembly 550 is engaged by moving the adjustable steering stem 120 to the upright or vertical position. Top hinge plate 610 is engaged on top of, and in contact with, bottom hinge plate 620 thereby positioning U-clasp 615 in proximity to lever pin 650. Foldable locking assembly 550 can be secured by positioning lever pin 650 within U-clasp 615 wherein U-clasp 615 is engaged between upper lever ring 660 and lower lever ring 670. Cam lever 640 is then rotatably engaged against upper lever ring 660 using lever handle 680. Once engaged, cam lever 640 compresses U-clasp 615 between upper lever ring 660 and lower lever ring 670 thereby locking top hinge plate 610 into position on top of and engaging bottom hinge plate 620. The adjustable steering stem 120 is then secured in the vertical position for use.

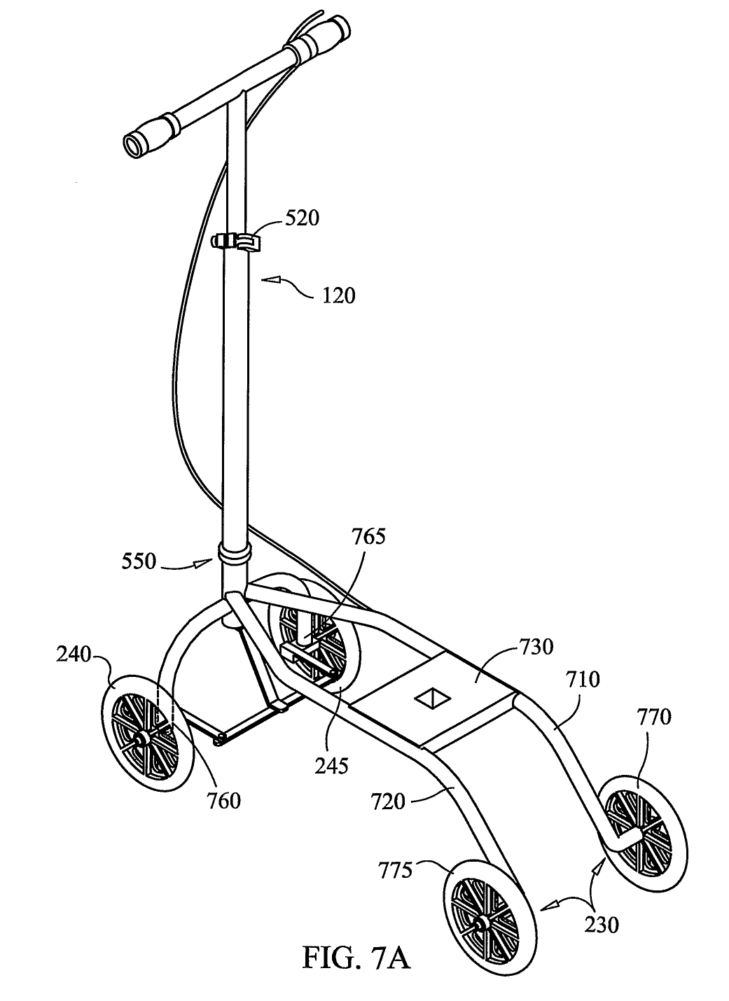

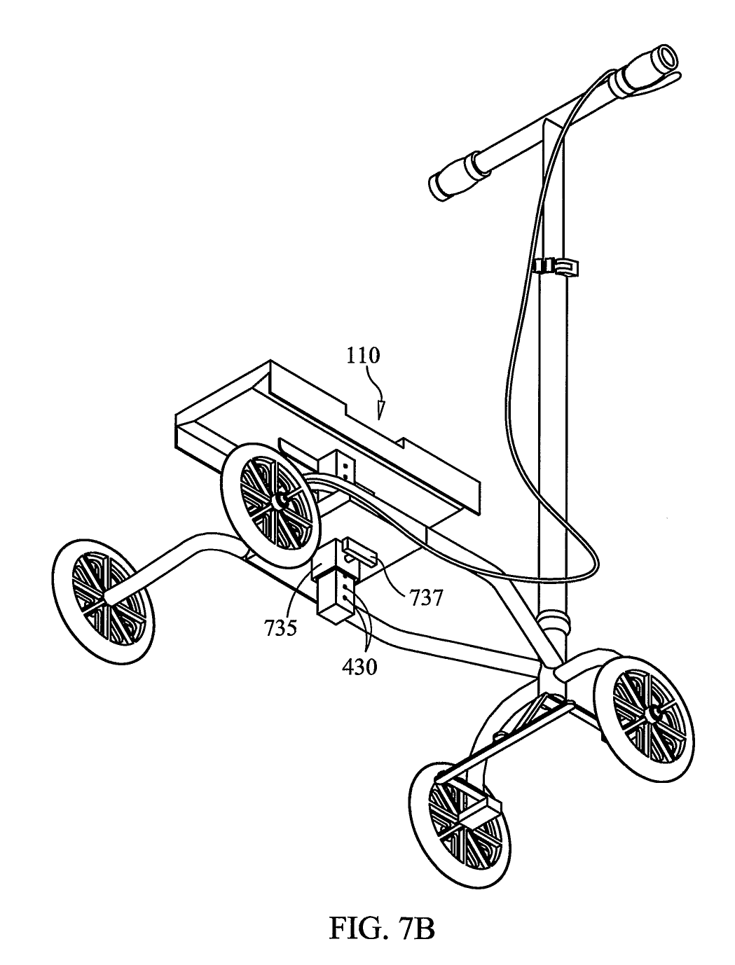

FIGS. 7A and 7B shows another embodiment of the frame 210. The frame 210 can be made of metal, steel, aluminum, composite material and graphite or like material. The frame 210 can be comprised of left side frame bar 710 and right side frame bar 720, platform mount 730, rear wheel mount 740, steering assembly mount 750, left directional arm mount 760 and right directional arm mount 765. The left side frame bar 710 and the right side frame bar 720 are horizontally adjacent and are substantially parallel along their lengths. The left side frame bar 710 and the right side frame bar 720 bend toward each other to connect to steering assembly mount 750. This configuration minimizes the bends necessary to manufacture the frame 210 while maintaining the stability of the kneeling walker 100 and also minimizes weight without compromising structural integrity. The configuration also allows the left front wheel 240 and right front wheel 245 to maintain a width greater than the width of the rear wheel assembly 230, thereby maintaining stability when the kneeling walker 100 is propelled forward during use. The platform mount 730 is centrally located between left side frame bar 710 and right side frame bar 720, being further comprised of stem receiver 735 and stop pin 737. Stop pin 737 engages length stops 430 and allows the adjustable support platform assembly 110 to be raised or lowered to accommodate the different heights of a user and to collapse the adjustable support platform assembly 110 for storage. The rear wheel assembly 230 is located on the distal end of frame 210 and is attached at the rear end of the left side frame bar 710 and the rear end of the right side frame bar 720. The rear wheel assembly 230 can be further comprised of the left rear wheel 770 and right rear wheel 775. The adjustable steering stem 120 is attached to the forward end of the frame 210 by the steering assembly mount 750 and is vertically positioned within the steering assembly mount 750.

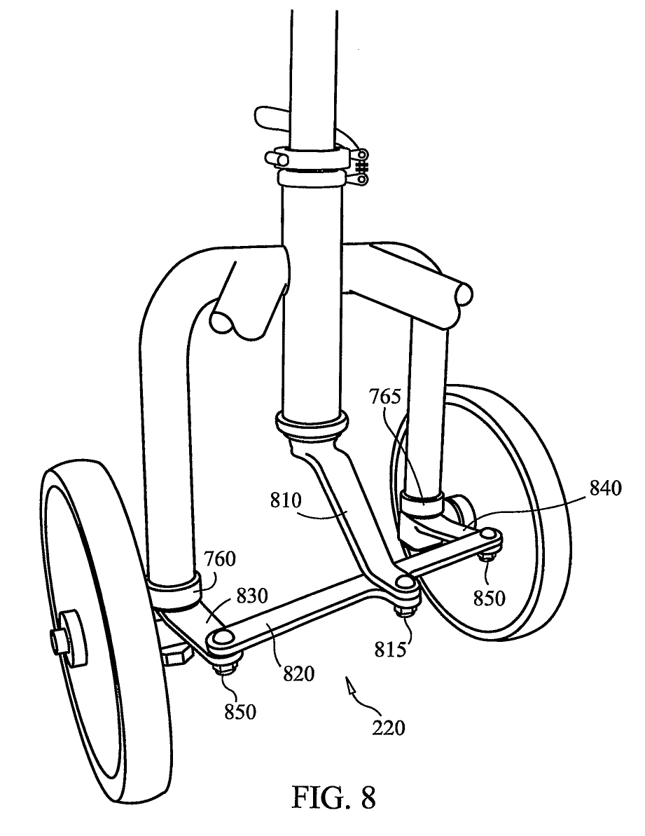

FIG. 8 shows an embodiment of the control assembly 220. Control assembly 220 can further be comprised of control arm 810, control bar 820, control arm pin 815, left directional arm 830, right directional arm 840 and control bar pins 850. The control arm 810 is attached to the distal end of adjustable steering stem 120 and extends down and rearward and is movably attached to control bar 820 with control arm pin 815. The left directional arm 830 and the right directional arm 840 are attached to the left directional arm mount 760 and right directional arm mount 765 respectively and are movably attached to the control bar 820 with directional arm pins 850. The kneeling walker 100 is turned or steered by the control assembly 220 through the manipulation of the adjustable steering stem 120. The control bar 820 allows the left front wheel 240 and right front wheel 245 to turn in unison. This configuration allows the front wheels to move without compromising the stability of the kneeling walker 100. Since the left front wheel 240 and right front wheel 245 are not affixed to a rigid axle, the location of the left front wheel 240 and right front wheel 245 in relation to the frame 210 is constant. The stability of the kneeling walker 100 is not compromised as the distance between the left front wheel 240 and right front wheel 245 relative to the width of the frame 210 and rear wheel assembly 230 remains unchanged. The likelihood of tipping during use is therefore minimized.

While the use of casters as wheels would similarly maintain the location of the front wheels in relation to the frame 210, casters offer no directional control and instead rely upon a change in propelling force direction rather than a repositioning of front wheel direction. This embodiment allows the user to turn the kneeling walker while maintain a propelling force direction without giving up the stability of fixed wheels. Stability is compromised with the use of casters as they are multi-directional and will allow the kneeling walker to move in any direction with a minimum of force. The use of steerable wheels also ensures directional accuracy while coasting or during rapid movement or when a misdirected propellant force is applied.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention not be limited by the specific embodiments described herein.

What is claimed is:

1. A kneeling walker comprising:
a steering assembly coupled to a frame of the kneeling walker, comprising:
a steering stem having a top end and a bottom end, said steering stem coupled to said kneeling walker; and
a control assembly coupled to said steering stem to rotate a left wheel and a right wheel about separate pivot points when said steering stem is rotated.

2. The kneeling walker of claim 1, wherein said control assembly further comprises:
a control arm;
a control bar;
a left directional arm;
a right directional arm; and
said control arm is attached to said bottom end and pivotally attached to said control bar, said left directional arm is pivotally attached to said left directional arm mount and pivotally attached to said control bar, said right directional arm being pivotally attached to said right directional arm mount and pivotally attached to said control arm, said left front wheel being rotatably attached to said left directional arm, said right front wheel being rotatably attached to said right directional arm.

3. The kneeling walker of claim 1, wherein said frame comprises:
a front end;
a back end;
a platform mount;
a steering assembly mount;
a rear wheel mount; and
said left wheel, said right wheel, and said steering assembly mount are connected to said front end; said rear wheel mount is connected to said back end; said platform mount is connected to said structure between said front end and said back end.

4. The kneeling walker of claim 3, further comprising at least one rear wheel rotatably attached to said rear wheel mount.

5. The kneeling walker of claim 1, further comprising a handle assembly coupled to said steering stem, comprising:
a left handle;
a right handle; and
a handle mount,
said left handle and said right handle are detachably connected to said handle mount, said handle mount being connected to said steering stem top end.

6. The kneeling walker of claim 5, wherein said handle assembly is detachably connected to said steering stem top end.

7. The kneeling walker of claim 1, wherein said steering stem rotates about a substantially vertical axis.

8. The kneeling walker of claim 1, further comprising a support platform adjustably and removably coupled to said frame of the kneeling walker.

9. The kneeling walker of claim 8, wherein said support platform further comprises at least one position indicator.

10. The kneeling walker of claim 8, wherein said support platform is rotatably adjustably connected to said frame of the kneeling walker.

11. The kneeling walker of claim 8, wherein said support platform comprises at least one pad.

12. The kneeling walker of claim 1, wherein said steering stem further comprises an adjustably locking telescoping tube.

13. The kneeling walker of claim 1, wherein said steering stem further comprises at least one position indicator.

14. The kneeling walker of claim 1, wherein said steering stem is hingeably attached to said frame of the kneeling walker such that said steering stem can be positioned in a substantially horizontal position.

15. The kneeling walker of claim 1, further comprising:
at least one hand brake lever;
at least one wheel brake; and
at least one brake cable operatively connected to said at least one hand brake lever and said at least one wheel brake.

16. The kneeling walker of claim 1, further comprising a support platform comprising:
a platform stem; and
a plate coupled to said platform stem.

17. The kneeling walker of claim 16, wherein said platform stem further comprises: a plurality of alignable openings; and said frame further comprises a pin and a receiving collar; said receiving collar having: a first opening extending parallel to its length for receiving said platform stem, and a second opening extending perpendicularly through its width for receiving said pin; said platform stem positionable within said first opening of said receiving collar and said pin positionable through said second opening of said receiving collar and through at least one of said plurality of alignable openings.

18. The kneeling walker of claim 16, wherein said plate is rotatably connected to said platform stem.

19. The kneeling walker of claim 16, wherein said platform stem further comprises at least one position indicator.

20. The kneeling walker of claim 16, wherein said platform stem is attached to said plate at a position substantially central relative to the length of said plate and substantially non-central relative to the width of said plate.
